(19) United States
(12) Patent Application Publication
(10) Pub. No.: US 2024/0384134 A1
(43) Pub. Date: Nov. 21, 2024

(54) ADHESIVE FILM AND MANUFACTURING METHOD OF DISPLAY DEVICE USING THE SAME

(71) Applicant: Samsung Display Co., Ltd., Yongin-Si (KR)

(72) Inventor: Jong Suk LEE, Yongin-si (KR)

(21) Appl. No.: 18/583,874

(22) Filed: Feb. 22, 2024

(30) Foreign Application Priority Data
May 18, 2023 (KR) 10-2023-0064359

(51) Int. Cl. C09J 7/20; C09J 7/40

(52) U.S. Cl. CPC C09J 7/203; C09J 7/403; C09J 2301/16; C09J 2301/50

(57) ABSTRACT

An adhesive film is disclosed that includes an adhesive layer, a first liner disposed on a first surface of the adhesive layer, and a second liner disposed on a second surface of the adhesive layer. The first liner includes a body overlapping the adhesive layer, and a plurality of wings extending from the body without overlapping the adhesive layer.

### CROSS-REFERENCE TO RELATED APPLICATION

This application claims priority to and the benefit of Korean Patent Application No. 10-2023-0064359 filed at the Korean Intellectual Property Office on May 18, 2023, the entire contents of which are incorporated herein by reference.

### BACKGROUND

### (a) Technical Field

This disclosure relates to a method of manufacturing an adhesive film and a display device, and more particularly, to a method of bonding a display panel and a cover window when manufacturing a display device having a curved surface area, and an adhesive film used for such bonding.

### (b) Description of the Related Art

Display devices such as light emitting display devices and liquid crystal displays are applied to electronic devices such as smart phones, mobile phones, and multimedia players. Since a display device, particularly a screen of the display device, is an externally visible part of the electronic device, the display device is a key element in the design of the electronic device.

Typically, the screen of the display device is flat. Recently, as flexible display devices have been developed, the screen is not limited to a flat surface, but may be formed in a curved surface and may include a bending area. In particular, if the edge of the display device is formed as a curved surface, the screen-to-body ratio of the display device may be increased. An aspect ratio can reflect the technological level of the display device and play an important role in a consumer's selection of a product. In addition, a curved edge may provide a better grip than an angular edge.

### SUMMARY

When manufacturing a display device including a curved region, a guide film may be used in a process of attaching a display panel and a cover window. For example, the display panel may be preformed by attaching a guide film to the display panel, disposing them on the pad, and pulling the guide film. When using the guide film, a process of attaching and removing the guide film from the display panel is required, and the guide film is a one-time material and is difficult to recycle. Embodiments may provide methods of manufacturing the display device capable of attaching the display panel and the cover window without using the guide film.

An embodiment of an adhesive film includes an adhesive layer, a first liner disposed on a first surface of the adhesive layer, and a second liner disposed on a second surface of the adhesive layer. The first liner includes a body overlapping the adhesive layer, and a plurality of wings extending from the body without overlapping the adhesive layer.

The body may include first and second sides parallel to a first direction, and third and fourth sides parallel to a second direction crossing the first direction. The plurality of wings may include a first wing and a second wing extending from the first side and the second side in a direction parallel to the second direction.

The plurality of wings may further include third and fourth wings extending from the third and fourth sides in a direction parallel to the first direction.

The body and the plurality of wings may be integrally formed.

The first liner may have a cross-shaped planar shape, and the second liner may have a quadrangular planar shape.

The adhesive film may further include a plurality of alignment marks formed in the first liner.

The plurality of alignment marks may be disposed in the body.

The plurality of alignment marks may be disposed in the plurality of wings.

The plurality of alignment marks may be printed on the first liner, engraved on the first liner, or formed to pass through the first liner.

An embodiment of a method of manufacturing a display device includes providing an adhesive sheet including the adhesive layer and a liner, forming a laminate in which the adhesive sheet and a display panel are bonded together, loading the laminate onto a pad so that the display panel faces the pad, loading a cover window into a jig, preforming the display panel by applying an external force to the liner to bring the display panel into close contact with a surface of the pad, removing the liner, and bonding the display panel and the cover window.

The pad may include an adhesive layer on a surface of the pad which contacts the display panel.

The surface of the pad may have an adhesive force of about 0.4 kgf/mm to about 1.5 kgf/mm.

The pad may include vacuum holes which communicating with the surface of the pad.

The liner may include a body overlapping the adhesive layer, and a plurality of wings extending from the body without overlapping the adhesive layer.

The body may include first and second sides parallel to a first direction, and third and fourth sides parallel to a second direction crossing the first direction. The plurality of wings may include a first wing and a second wing extending from the first side and the second side in a direction parallel to the second direction. The first wing and the second wing may be clamped in the preforming of the display panel.

The plurality of wings may further include third and fourth wings extending from the third and fourth sides in a direction parallel to the first direction.

A plurality of alignment marks may be formed in the liner, and the display panel and the cover window may be aligned using the plurality of alignment marks.

When the adhesive sheet and the display panel are bonded, an alignment error between the liner and the display panel may be obtained using the plurality of alignment marks, and when the display panel and the cover window are aligned, an alignment position may be corrected using the alignment error.

The liner may include a body overlapping the adhesive layer, and a plurality of wings extending from the body without overlapping the adhesive layer.

The alignment mark may be formed in the body, and positions of the plurality of alignment marks may not be distorted in a state in which the display panel is preformed.

When the laminate is loaded, the display panel and the pad may be aligned using the plurality of alignment marks.

According to the embodiments, when manufacturing a display device including a curved area, the display panel and the cover window may be bonded together without using a guide film, thereby reducing cost and process steps. Further, according to the embodiments, there are advantageous effects that can be recognized throughout the specification.

### BRIEF DESCRIPTION OF THE DRAWINGS

FIG. 1 is a schematic perspective view of an embodiment of an electronic device which includes a display device.

FIG. 2 is a schematic cross-sectional view of a display device taken along line A-A′ in FIG. 1.

FIG. 3 is a top plan view schematically illustrating an adhesive film according to an embodiment.

FIG. 4 is a schematic cross-sectional view taken along line B-B′ in FIG. 3.

FIG. 5 is a top plan view illustrating a state in which a display panel is attached to an adhesive film shown in FIG. 3.

FIG. 6 is a schematic cross-sectional view taken along line C-C′ in FIG. 4.

FIG. 7 is a perspective view schematically illustrating a lamination apparatus and a laminate loaded therewith according to an embodiment.

FIGS. 8, 9, 10, 11, and 12 are drawings schematically illustrating steps of attaching a display panel and a cover window.

FIG. 13 is a plan view schematically illustrating an adhesive film according to an embodiment.

FIG. 14 is a cross-sectional view schematically illustrating a stacked structure of a display panel according to an embodiment.

### DETAILED DESCRIPTION OF THE EMBODIMENTS

With reference to the accompanying drawings, embodiments will be described in detail.

In the drawings, the size and thickness of each component are arbitrarily shown for convenience of description.

When a part such as a layer, film, region, plate, etc. is said to be “above” or “on” another part, this includes not only the case where it is “directly on” another element, but also the case where there is another element in the middle.

Conversely, when a component is said to be “directly on top” of another component, it means that there are no intervening components.

As used herein, the word “or” means logical “or” so that, unless the context indicates otherwise, the expression “A, B, or C” means “A and B and C,” “A and B but not C,” “A and C but not B,” “B and C but not A,” “A but not B and not C,” “B but not A and not C,” and “C but not A and not B.”

Throughout the specification, “connected” does not mean only when two or more components are directly connected, but when two or more components are indirectly connected through another component, physically connected, or electrically connected. In addition to this case, it may include a case where each part, referred to by a different name according to its location or function but substantially integral, is connected to each other.

In the drawings, the symbols “x,” “y,” and “z” are used to indicate directions, where “x” is a first direction, “y” is a second direction perpendicular to the first direction, and “z” is a third direction perpendicular to the first and second directions.

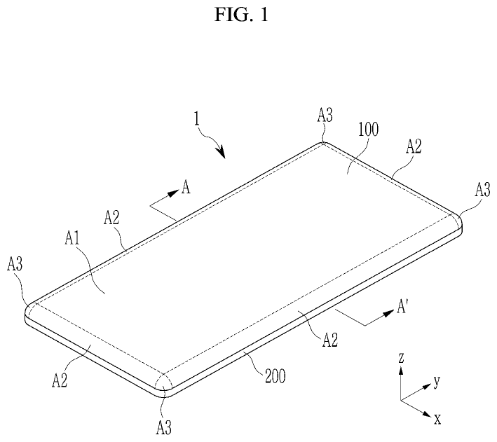

FIG. 1 is a schematic perspective view of an embodiment of an electronic device which includes a display device.

Referring to FIG. 1, a display device 100 according to an embodiment may be applied to an electronic device 1 such as a smart phone, a mobile phone, a tablet PC, a multimedia player, or a game machine. The electronic device 1 may include the display device 100 and a housing 200. The display device 100 provides a screen on which an image is displayed in the electronic device 1. The housing 200 may be referred to as a set frame, and may fix the display device 100. In the inner space defined by the display device 100 and the housing 200, various portions constituting the electronic device 1 are positioned. For example, a processor, a memory, a battery, a driving device, a camera, a speaker, a microphone, a receiver, a communication module, or a sensor may be positioned inside the electronic device 1. When viewed from the front, the electronic device 1 and the display device 100 may have a substantially rectangular shape.

The entire front surface of the electronic device 1 and the display device 100 may correspond to the screen, and at least a portion of the side surface may also correspond to the screen. The screen may correspond to the display area of the display device 100. The display area may be positioned on the side as well as the front of the electronic device 1 and the display device 100.

At least one of the four edge areas of the display device 100 may be bent. In the illustrated embodiment, the display device 100 has four bent edge regions. When bent as described above, the display device 100 includes a front portion A1 (or first region) positioned on the front side, a side portion A2 (or second region) positioned on a side surface of the front portion A1, further, it may include a corner portion A3 (or third region) positioned at corner of the front portion A1. Although four side portions A2 and four corner portions A3 are shown, the display device 100 may include one or more side portions A2, and may or may not include one or more corner portions A3.

The front portion A1 may be positioned in the center of the display device 100 and may occupy most of the screen. The side portions A2 and the corner portions A3 may be positioned around the front portion A1. The front portion A1 may constitute a front display area. Most of the side portions A2 may constitute a side display area, and most of the corner portions A3 may constitute a corner display area. The front portion A1 may be a flat surface, and the side portions A2 and corner portions A3 may be curved surfaces. Edges of the side portions A2 and edges of the corner portions A3 may be non-display areas—that is regions in which images are not displayed.

The front portion A1 may occupy the widest area of the entire display area and form a substantially flat screen. In a plan view, the front portion A1 may be a rectangle having four sides as a whole. The corner of the front portion A1 may be sharp as shown, but may also be rounded. Two of the four sides of the front portion A1 may be parallel to each other in the first direction x and two other sides of the front portion A1 may be parallel to each other in the second direction y.

The side portions A2 may be connected to the four sides of the front portion A1, respectively. Each of the side portions A2 may form a curved surface (e.g., a single curved surface), and the curvature may be constant or different depending on the position of the curved surface. Each side portion A2 may have a shape similar to a portion (for example, ¼) of a side surface of a curved column such as an elliptical column or a cylinder. As another example, the side portion A2 may have a curved surface in an area close to the front portion A1 and a flat surface in an area far from the front portion A1.

The corner portions A3 may be positioned at four corners of the display device 100. Each corner portion A3 may be positioned between two adjacent side portions A2. Each corner portion A3 may form a curved surface (e.g., a double curved surface).

The curvature of the curved surface may be constant or different depending on the location. The shape of the curved surface of the corner portion A3 may be different from the shape of the curved surface of the side portion A2. For example, each corner portion A3 may have a shape similar to a part (e.g., ⅛) of a curved body such as a sphere or an elliptical sphere.

When the electronic device 1 is viewed from the front, the entire front portion A1, the side portions A2, and the corner portions A3 are combined to be recognized as a rectangular screen with rounded corners as a whole. The housing 200 may be invisible or almost invisible, and a substantially bezel-less electronic device 1 having an aspect ratio of 1 or nearly 1 may be implemented.

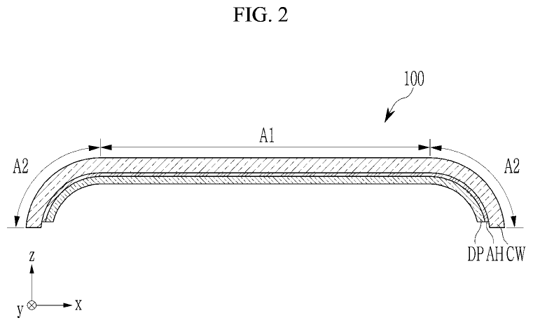

FIG. 2 is a schematic cross-sectional view of the display device taken along line A-A′ in FIG. 1.

Referring to FIG. 2, the display device 100 may include a display panel DP and a cover window CW positioned in front of the display panel DP. An adhesive layer AH may be positioned between the display panel DP and the cover window CW to attach them. The display panel DP and the cover window CW are the front portion A1 and the side portions A2 corresponding to the front portion A1, the side portions A2 and the corner portions A3 of the display device 100.

In the display device 100, an image may be displayed by the display panel DP. The display panel DP may be a light emitting display panel including light emitting devices such as light emitting diodes. The display panel DP may be a touch screen panel including a touch sensor layer capable of detecting a touch. At least a portion of the display panel DP may be flexible. The display panel DP may include a display area corresponding to a screen on which an image is displayed and a non-display area on which an image is not displayed.

Pixels are arranged in the display area, and an image can be displayed by a combination of the pixels. Pixel circuits and signal lines for driving pixels may be disposed in the display area. The signal lines may include gate lines for transmitting gate signals, data lines for transmitting data signals, and the like. In the display area, gate lines may extend in a first direction x, and data lines may extend in a second direction y. Each pixel may be connected to a pixel circuit connected to a data line and a gate line to receive a data signal (voltage) for controlling luminance of the pixel at a predetermined timing. The display area may be positioned not only on the front portion A1 but also on the side portions A2 and the corner portions A3.

The non-display area may be positioned near the edge of the display panel DP and may be positioned around the display area. In the non-display area, circuits or wires for generating or transmitting various signals may be applied to the display area, and signals may be received from outside the display panel DP or a pad portion (or connection terminal portion) including pads for outputting signals to the outside. A flexible printed circuit film (not shown) may be bonded to the pad portion.

Edge regions of the display panel DP may be bent to form the side portions A2 and the corner portions A3. When viewing the display device 100 from the front, the non-display area may not be visible. Accordingly, the screen may occupy a region visible when viewing the display device 100 from the front, and the aspect ratio of the display device 100 may be maximized.

The cover window CW may cover the display panel DP and transmit an image displayed by the display panel DP. Edge regions of the cover window CW may be bent to form the side portions A2 and the corner portions A3. The display panel DP may be protected from the external environment, impact, or the like.

The cover window CW may serve as a support for maintaining the display panel DP in a bent state. The cover window CW may be formed of a transparent and hard material such as glass or plastic. At least a region of the cover window CW corresponding to the display screen may be optically transparent. Here, “optically transparent” may mean that visible light transmittance is about 70% or more, about 80% or more, or about 90% or more. Bending of the cover window CW may be performed by thermoforming—for example, a glass plate or a plastic plate.

The display panel DP and the cover window CW may be bonded together. For example, the front surface of the display panel DP and the rear surface of the cover window CW may be bonded together. An adhesive such as an optically clear adhesive may be used to bond the display panel DP and the cover window CW, and an adhesive layer AH formed of such an adhesive is between the display panel DP and the cover window CW.

Hereinafter, a method of manufacturing the display device 100 by bonding the display panel DP and the cover window CW will be described in detail.

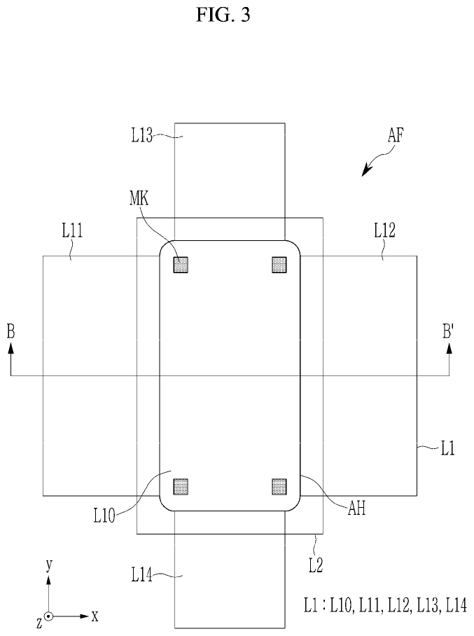

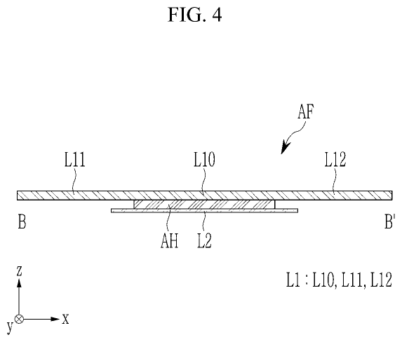

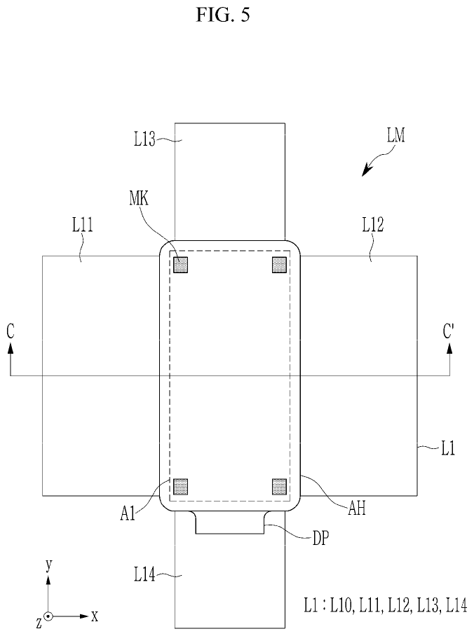

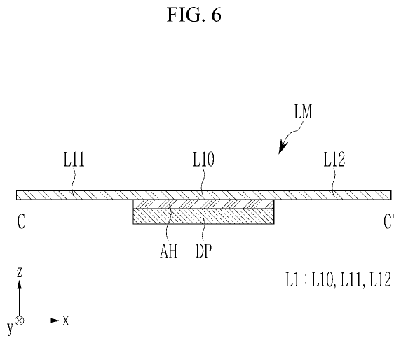

FIG. 3 is a plan view schematically illustrating an adhesive film according to an embodiment, and FIG. 4 is a schematic cross-sectional view taken along line B-B′ in FIG. 3. FIG. 5 is a plan view illustrating a state in which a display panel is attached to the adhesive film shown in FIG. 3, and FIG. 6 is a schematic cross-sectional view taken along line C-C′ in FIG. 4.

Referring to FIG. 3 and FIG. 4, an adhesive film AF used to bond the display panel DP and the cover window CW is shown. The adhesive film AF includes an adhesive layer AH, a first liner L1 positioned on the first surface (upper surface) of the adhesive layer AH, and a second surface (lower surface) of the adhesive layer AH may include a second liner L2. The first liner L1 and the second liner L2 may be called a tight liner and an easy liner, respectively. The first liner L1 may cover the entire first surface of the adhesive layer AH, and the second liner L2 may cover the entire second surface of the adhesive layer AH. Due to the adhesive force of the adhesive layer AH, the first liner L1 and the second liner L2 may be attached to the first and second surfaces of the adhesive layer AH, respectively. Accordingly, it is possible to prevent the adhesive layer AH from contacting or sticking to another object before using the adhesive film AF. The adhesive layer AH may be optically transparent. The first liner L1 or the second liner L2 may be optically transparent.

The first liner L1 may include a body L10 overlapping the adhesive layer AH, and wings L11-L14 extending from the body L10 without overlapping the adhesive layer AH. The body L10 and the wings L11-L14 may be integrally formed.

The body L10 may have an overall rectangular shape and may have rounded corners. The body L10 may include first and second sides parallel to the first direction x, and third and fourth sides parallel to the second direction y. The body L10 may be the same as or slightly larger than the adhesive layer AH. Alignment marks MK may be positioned in the body L10. For example, four alignment marks MK may be positioned near the four corners of the body L10. The alignment marks MK may be printed on one side of the first liner L1. The alignment marks MK may be engraved on one surface of the first liner L1. The alignment marks MK may be formed to pass through the first liner L1. The number, location, and shape of the alignment marks MK may be variously changed. For example, the alignment marks MK may have various shapes other than the illustrated rectangle. At least some of the alignment marks MK may be positioned at a boundary between the body L10 and the wings L11-L14 or at the wings L11-L14.

The wings L11-L14 may include a first wing L11 and a second wing L12 that extend in a direction parallel to the first direction x from two sides parallel to the second direction y of the body L10, and a third wing L13 and a fourth wing L14 that extend in a direction parallel to the second direction y from two sides parallel to the first direction x of the body L10. Each of the wings L11-L14 may be approximately rectangular. The first liner L1 including the body L10 and the wings L11-L14 may have a substantially cross-shaped planar shape as a whole. In another embodiment, the first liner L1 may include only the first and second wings L11 and L12 of the wings L11-L14, or may include only the third and fourth wings L13 and L14.

The second liner L2 may have a substantially rectangular shape—for example, a substantially rectangular shape. The second liner L2 may completely cover the second surface of the adhesive layer AH. The second liner L2 may be larger than the adhesive layer AH. The second liner L2 may be thinner than the first liner L1.

Referring to FIG. 5 and FIG. 6, the second liner L2 is removed from the adhesive film AF, and the display panel DP is bonded to the adhesive film AF, so that the display panel DP and the adhesive layer AH and the first liner L1 may form a laminate LM. The display panel DP may be attached to the second surface of the adhesive layer AH, which is the surface from which the second liner L2 is removed. The sub-bonding of the display panel DP to the adhesive film AF to form the laminate LM may be performed by a roll lamination method. An area of the display panel DP where a pad portion is positioned (i.e., a connection area where the flexible printed circuit film is bonded) may not be attached to the adhesive layer AH, and may overlap the fourth wing L14. The first to third wings L11-L13 may not overlap the display panel DP. The alignment marks MK of the first liner L1 may overlap the front portion A1 of the display panel DP. During sub-bonding, the first liner L1 and the display panel DP may be aligned by recognizing the alignment marks MK of the first liner L1 and marks (not shown) of the display panel DP.

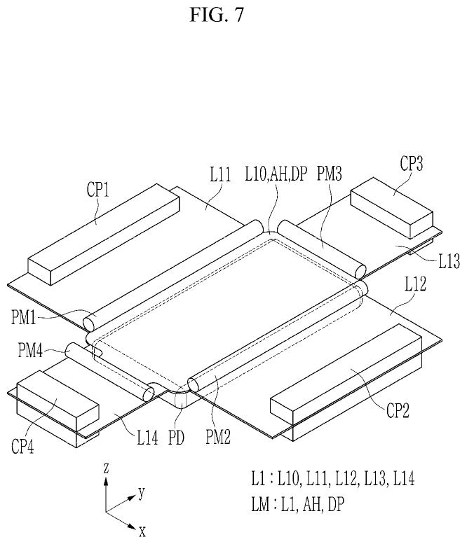

FIG. 7 is a perspective view schematically illustrating a lamination apparatus and a laminate LM loaded therewith according to an embodiment. Referring to FIG. 7, the lamination apparatus may include a pad PD, clamps CP1-CP4, and pushers PM1-PM4. The pad PD may have a substantially rectangular planar shape as a whole. The clamps CP1-CP4 and the pushers PM1-PM4 may be disposed to correspond to four sides of the pad PD. To attach the display panel DP and the cover window CW, the laminate LM including the display panel DP, the adhesive layer AH, and the first liner L1 may be loaded on the pad PD. The laminate LM may be located so that the display panel DP faces the pad PD. That is the display panel DP, the adhesive layer AH, and the body L10 may be disposed to sequentially overlap the pad PD. The wings L11-L14 may be clamped to corresponding clamps CP1-CP4. For example, edge portions of each of the wings L11-L14 may be fixed to corresponding clamps CP1-CP4. The pushers PM1-PM4 may be positioned on corresponding wings L11-L14.

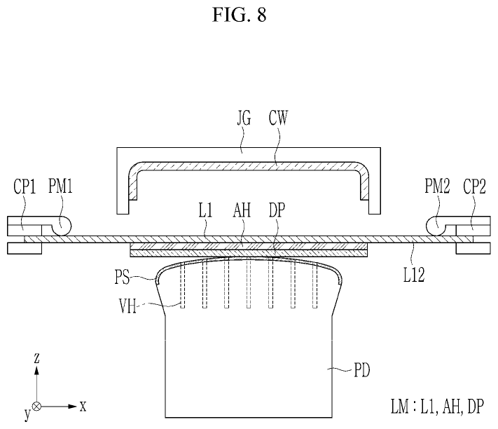

FIGS. 8, 9, 10, 11, and 12 are drawings schematically illustrating steps of attaching the cover window to the display panel DP.

Referring to FIG. 8, for main bonding of the display panel DP and the cover window CW, first a step of loading the laminate LM into a lamination apparatus may be performed. The state shown in FIG. 8 may be substantially the same as the state shown in FIG. 7. In a state in which the laminate LM is loaded, the wings L11-L14 of the first liner L1 may be clamped to the clamps CP1-CP4, and the laminate LM is positioned flat in the horizontal direction. Meanwhile, the cover window CW may be loaded on a jig JG before or after loading the laminate LM. The jig JG may fix the cover window CW by using a vacuum adsorption means, an electrostatic chuck, or the like. The main bonding may be performed in a vacuum chamber. It is possible to prevent the occurrence of foreign substances or bubbles during vacuum bonding, and it is possible to increase the alignment precision.

A pre-alignment step, which aligns the display panel DP and the pad PD, may be performed so that the display panel DP may be accurately loaded on the pad PD when the laminate LM is loaded. For example, a vision alignment device can be used to align the display panel DP and the pad PD by recognizing an alignment mark MK marked on the first liner L1 and an alignment mark (not shown) marked on the pad PD. Typically, an alignment mark for aligning the display panel DP and the pad PD is formed in a non-display area of the display panel DP, and the non-display area may include an area where the alignment mark is formed. As in the embodiment, by forming the alignment mark MK on the first liner L1, the corner area of the display panel DP may be reduced, and thus the non-display area and dead space of the display panel DP may be reduced.

The alignment marks MK of the first liner L1 and marks of the display panel DP (shown in FIG. position of the first liner L1 and the display panel DP and an alignment error (or alignment mark) between the first liner L1 and the display panel DP by recognizing through a vision alignment device including a camera, the relative positions of the marks of the display panel DP with respect to the alignment marks MK may be obtained.

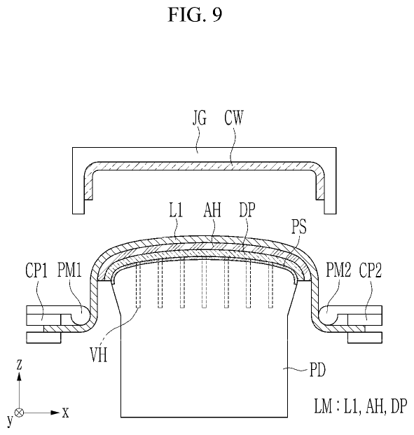

Referring to FIG. 9, a preforming step of deforming the shape of the display panel DP by applying an external force to the first liner L1 may be performed. With the display panel DP, which is bonded to the first liner L1 by the adhesive layer AH, loaded on the pad PD, the pushers PM1-PM4 may be arranged on the wings L11-L14 of the first liner L1. An external force (e.g., tensile force) is applied to the first liner L1 while bringing the first liner L1 into close contact with the side surface of the pad PD using the pushers PM1-PM4 to move the display panel DP to the pad PD, which can be preformed into a shape that matches the surface shape. An external force may be applied to the first wing L11 by the first pusher PM1, an external force may be applied to the second wing L12 by the second pusher PM2, a third wing L13 may be applied with an external force by the third pusher PM3, and external force may be applied to the fourth wing L14 by the fourth pusher PM4.

The external force of the pushers PM1-PM4 may be applied by lowering the clamps CP1-CP4 coupled thereto or by raising the pad PD loaded with the laminate LM. The first liner L1 may be bent by an external force on the first liner L1. For example, the body L10 of the first liner L1 may be deformed to have a curvature. When the first liner L1 is deformed, the display panel DP bonded to the body L10 may also be deformed. For example, as shown in FIG. 1 and FIG. 2, the display panel DP may be deformed to include bent side portions A2 and corner portions A3. Through the preforming step, the display panel DP may adhere to the pad PD. Also, the display panel DP may be formed so that the central portion of the front portion A1 is more convex in the third direction z than other portions.

After the preforming step, a main alignment step of aligning the display panel DP and the cover window CW may be performed. For example, by using a vision alignment device, the alignment marks MK displayed on the first liner L1 and the alignment marks (not shown) displayed on the cover window CW are recognized, and the display panel DP and the cover window are recognized. The positions of the cover window CW may be compared and the display panel DP, and the cover window CW may be aligned. During the main alignment of aligning the display panel DP and the cover window CW, the alignment position may be corrected using an alignment error between the first liner L1 and the display panel DP obtained before the preforming step. Therefore, during the main alignment, the position of the display panel DP can be tracked and specified without using the alignment mark used for the display panel DP, and the display panel DP and the cover window CW can be accurately aligned.

Typically, the marks of the display panel DP are disposed in an edge area of the display panel DP, which is a non-display area. This is because when the marks are disposed in the display area, it may be difficult to recognize the marks due to interference with pixels or conductors positioned in the display area. When the display panel DP is preformed, the non-display area of the display panel DP is disposed on the side surface of the pad PD by the bent side portions A2 and corner portions A3, so that the non-display area in the position of the placed marks may be distorted (e.g., the position of the marks shifted when viewed from above). Therefore, during normal alignment based on the marks of the display panel DP, the positions of the marks of the display panel DP may be erroneously recognized, and the alignment of the display panel DP and the cover window CW may exceed tolerance. Unlike when the marks are disposed on the display panel DP, when the alignment marks MK are disposed on the first liner L1, there are no restrictions on their positions. As in the embodiment, when the alignment marks MK are disposed on the first liner L1 in an area overlapping the front portion A1 of the display panel DP, the positions of the alignment marks MK are distorted even after preforming. Accordingly, the display panel DP and the cover window CW may be more accurately aligned during the main alignment based on the alignment marks MK of the first liner L1.

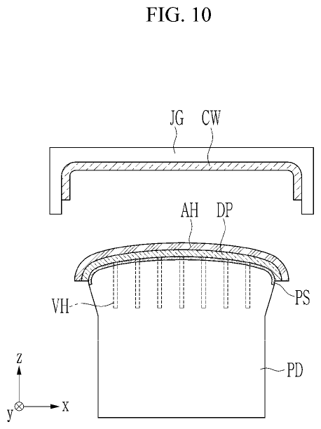

Referring to FIG. 10, after the main alignment step, the first liner L1 may be removed. Accordingly, the display panel DP attached to the pad PD and the adhesive layer AH attached to the display panel DP may be positioned on the pad PD. To keep the display panel DP in close contact with the pad PD—that is in a preformed state—the display panel DP may be attached to or adsorbed to the pad PD.

A physical sticky chuck PSC, a vacuum chuck, or the like may be applied to the pad PD so that the display panel DP can be attached to or adsorbed to the pad PD. When the physical adhesive chuck is applied, the adhesive force of the surface of the pad PD in contact with the display panel DP may be about 0.4 kgf/mm to about 1.5 kgf/mm. For this adhesive force, the surface of the pad PD may include an adhesive layer PS such as adhesive rubber. The adhesive layer PS may be positioned on the entire surface of the pad PD contacting the display panel DP or only on a part of the surface. The adhesive layer PS may be formed by coating an adhesive material or attaching an adhesive sheet to the surface of the pad PD. If the adhesive force of the pad PD is less than about 0.4 kgf/mm, a part of the display panel DP may be separated from the surface of the pad PD due to the repulsive force of the display panel DP and may not maintain its preformed state. However, if the adhesive force of the pad PD is greater than about 1.5 kgf/mm, it may be difficult for the display panel DP to be separated from the pad PD after the display panel DP and cover window CW are attached.

When the vacuum chuck is applied, the pad PD may include a plurality of vacuum holes VH communicating with a porous material—that is a surface in contact with the display panel DP—and the lamination device, which applies negative pressure, may include devices (not shown) such as vacuum pumps, blowers, fans, cylinders, etc. that provide positive pressure. When negative pressure (vacuum force) is applied to the vacuum holes VH, the pad PD may vacuum-suck the display panel DP preformed thereon or enhance the adsorption force. When negative pressure is released or positive pressure is applied to the vacuum holes, the display panel DP may be detached from the pad PD.

When the physical adhesive chuck and the vacuum chuck are simultaneously applied, the display panel DP can be attached and detached more easily.

In this case, even if the adhesive force on the surface of the pad PD increases more than the above-mentioned range, the display panel DP can be maintained in its preformed state and the display panel DP can be detached because vacuum adsorption and detachment are performed concurrently. For example, the adhesive force of the surface of the pad PD may be about 0.2 kgf/mm to about 2.0 kgf/mm. Meanwhile, an electrostatic chuck may be further provided on the pad PD so as to enhance the adsorption force of the display panel DP and to more easily attach or detach the display panel DP.

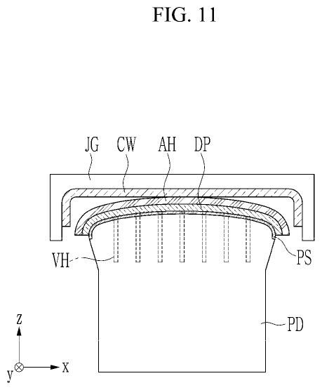

Referring to FIG. 11, after the main alignment, the pad PD can be raised, the jig JG can be lowered, or the pad PD can be raised and the jig JG can be lowered to bring the adhesive layer AH located in the central area of the display panel DP into contact with the cover window CW. At this time, the display panel DP may maintain the preforming so that the adhesive layer AH does not contact the cover window CW at the side portions A2 and the corner portions A3 of the display panel DP. This is because if the adhesive layer AH of the bending area first contacts the cover window CW, the adhesion quality may be deteriorated, such as air bubbles between the display panel DP and the cover window CW.

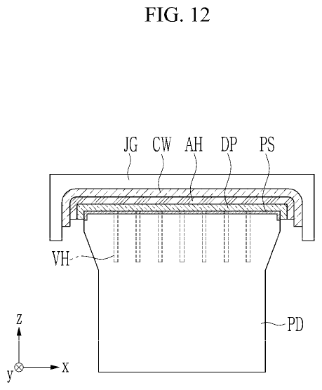

Next, referring to FIG. 12, the display panel DP is bonded to the cover window CW by applying pressure through the pad PD while the adhesive layer AH is in contact with the cover window CW. First, the front portion A1 of the display panel DP is bonded to the cover window CW, and then the side portions A2 and corner portions A3 of the display panel DP are bonded to the cover window CW. The pad PD may include an air pump or may be connected to the air pump. The pad PD may include a diaphragm.

After the main bonding process is completed, the pad PD is lowered, the jig JG is raised, or the pad PD is lowered and the jig JG is raised to move the pad PD to the display panel DP. Thereafter, the display device 100 to which the display panel DP and the cover window CW are bonded may be unloaded from the jig JG to complete the main bonding. Air bubbles that may exist between the bonded display panel DP and the cover window CW of the display device 100 may be removed through an autoclave process.

In this way, according to the embodiment, the display panel DP and the cover window CW may be bonded together without using a guide film. Therefore, the cost of using the guide film can be reduced or eliminated. In addition, since the guide film is not used, there is no need for a process of bonding the guide film and the display panel DP, and, after bonding the display panel DP and the cover window CW, there is no need for irradiating ultraviolet rays to remove the guide film. Since a process of losing or lowering the adhesive strength of the adhesive layer attaching the guide film and the display panel DP is not required, the number of process steps can be reduced.

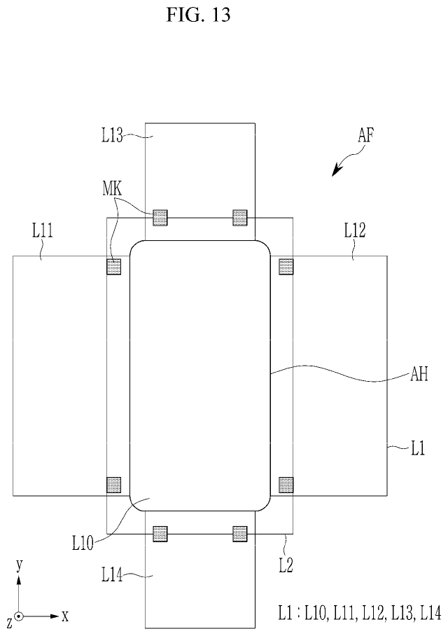

FIG. 13 is a plan view schematically illustrating an adhesive film according to an embodiment.

The adhesive film AF shown in FIG. 13 has a difference in position of the alignment marks MK compared to the adhesive film AF shown in FIG. 3. The alignment marks MK may be positioned on wings L11-L14. The alignment marks MK may be positioned close to the body L10. These alignment marks MK may be positioned on the side of the pad PD during preforming (see FIG. 9). Main alignment may be performed in a preformed state by recognizing the alignment marks MK positioned on the side using an edge camera of the vision alignment device. However, since a plurality of edge cameras must be used or the edge cameras must be moved, as shown in FIG. 3, it may be more disadvantageous than arranging the alignment marks MK on the body L10.

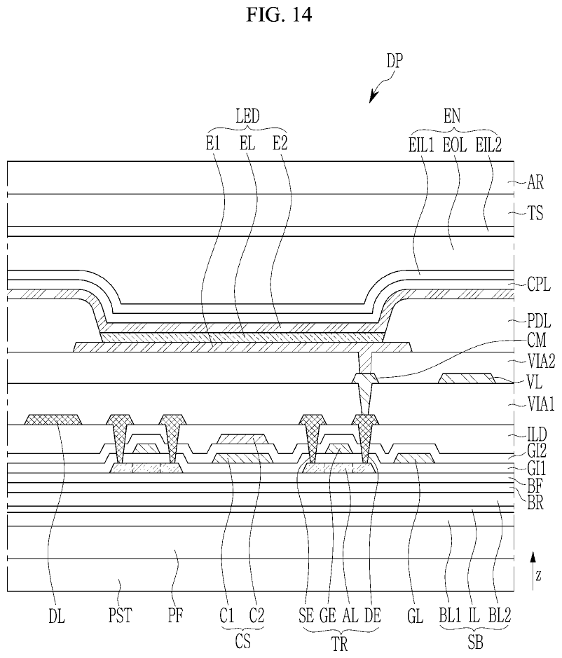

FIG. 14 is a cross-sectional view schematically illustrating a stacked structure of a display panel according to an embodiment.

The cross-section shown in FIG. 14 may correspond to approximately one pixel area. Referring to FIG. 14, the display panel DP, which can be bonded to the cover window CW using the aforementioned adhesive film AF, basically includes a substrate SB, a transistor TR formed on the substrate SB, and a light emitting diode LED connected to the transistor TR. A light emitting diode LED may correspond to a pixel.

The substrate SB may be a flexible substrate SB capable of being bent, folded, or rolled. The substrate SB may have a multilayer structure including a first base layer BL1, an inorganic layer IL, and a second base layer BL2. The first base layer BL1 and the second base layer BL2 may include a polymer resin such as polyimide, polyamide, or polyethylene terephthalate. A barrier layer BR may be positioned on the substrate SB to prevent penetration of moisture, oxygen, or the like. The barrier layer BR may include an inorganic insulating material such as silicon nitride (SiNₓ), silicon oxide (SiOₓ), or silicon oxynitride oxide (SiOₓN_{y}), and may have a single layer or multiple layers.

A buffer layer BF may be positioned on the barrier layer BR. The buffer layer BF can improve the characteristics of the semiconductor layer by blocking impurities from the substrate SB during formation of the semiconductor layer, and can relieve stress of the semiconductor layer by planarizing the surface of the substrate SB. The buffer layer BF may include an inorganic insulating material such as silicon nitride, silicon oxide, or silicon oxynitride, and may have a single layer or multiple layers. The buffer layer BF may include amorphous silicon (a-Si).

A semiconductor layer AL of the transistor TR may be positioned on the buffer layer BF. The semiconductor layer AL may include a first region, a second region, and a channel region between these regions.

The semiconductor layer AL may include any one of amorphous silicon, polycrystalline silicon, and an oxide semiconductor. The oxide semiconductor may include at least one of zinc (Zn), indium (In), gallium (Ga), and tin (Sn). For example, the semiconductor layer AL may include low-temperature polycrystalline silicon (LTPS) or indium-gallium-zinc oxide (IGZO).

A first gate insulating layer GI1 may be positioned on the semiconductor layer AL. The first gate insulating layer GI1 may include an inorganic insulating material such as silicon nitride, silicon oxide, or silicon oxynitride, and may have a single layer or multiple layers.

A first gate conductive layer that may include the gate electrode GE of the transistor TR, the gate line GL, the first electrode C1 of the storage capacitor CS, and the like is formed on the first gate insulating layer GI1 and can be positioned thereon. The first gate conductive layer may include molybdenum (Mo), aluminum (Al), copper (Cu), titanium (Ti), or the like, and may be a single layer or multiple layers.

A second gate insulating layer GI2 may be positioned on the first gate conductive layer. The second gate insulating layer GI2 may include an inorganic insulating material such as silicon nitride, silicon oxide, or silicon oxynitride, and may have a single layer or multiple layers.

A second gate conductive layer that may include the second electrode C2 of the storage capacitor CS may be positioned on the second gate insulating layer GI2. The second gate conductive layer may include molybdenum (Mo), aluminum (Al), copper (Cu), titanium (Ti), or the like, and may be a single layer or multiple layers.

An interlayer insulating layer ILD may be positioned on the second gate insulating layer GI2 and the second gate conductive layer. The interlayer insulating layer ILD may include an inorganic insulating material such as silicon nitride, silicon oxide, or silicon oxynitride, and may have a single layer or multiple layers.

A first data conductive layer, which may include the first electrode SE and second electrode DE of the transistor TR, and the data line DL, may be positioned on the interlayer insulating layer ILD. The first electrode SE and the second electrode DE may be connected to the first and second regions, respectively, of the semiconductor layer AL through contact holes formed in the first gate insulating layer GI1, the second gate insulating layer GI2, and the interlayer insulating layer ILD. One of the first electrode SE and the second electrode DE may be a source electrode, and the other may be a drain electrode. The first data conductive layer includes aluminum (Al), platinum (Pt), palladium (Pd), silver (Ag), magnesium (Mg), gold (Au), nickel (Ni), neodymium (Nd), and iridium (Ir), chromium (Cr), calcium (Ca), molybdenum (Mo), titanium (Ti), tungsten (W), copper (Cu), etc., and may be a single layer or multiple layers.

A first planarization layer VIA1 may be positioned on the first data conductive layer. The first planarization layer VIA1 may include a general purpose polymer such as poly(methyl methacrylate) or polystyrene, a polymer derivative having a phenolic group, an acrylic polymer, or an imide polymer (e.g., polyimide), and organic insulating materials such as siloxane-based polymers.

A second data conductive layer that may include a voltage line VL, a connection member CM, and the like may be positioned on the first planarization layer VIA1. The voltage line VL may transmit voltages such as a driving voltage, a common voltage, an initialization voltage, or a reference voltage. The connecting member CM may be connected to the second electrode DE of the transistor TR through a contact hole of the first planarization layer VIA1. The second data conductive layer includes aluminum (Al), platinum (Pt), palladium (Pd), silver (Ag), magnesium (Mg), gold (Au), nickel (Ni), neodymium (Nd), iridium (Ir), chromium (Cr), calcium (Ca), molybdenum (Mo), titanium (Ti), tungsten (W), copper (Cu), etc., and may be a single layer or multiple layers.

A second planarization layer VIA2 may be positioned on the second data conductive layer. The second planarization layer VIA2 may include an organic insulating material such as a general purpose polymer such as polymethyl methacrylate or polystyrene, a polymer derivative having a phenolic group, an acrylic polymer, an imide polymer, or a siloxane polymer.

A first electrode E1 of the light emitting diode LED may be positioned on the second planarization layer VIA2. The first electrode E1 may be referred to as a pixel electrode. The first electrode E1 may be connected to the connection member CM through a contact hole of the second planarization layer VIA2. Accordingly, the first electrode E1 may be electrically connected to the second electrode DE of the transistor TR to receive a driving current for controlling the luminance of the light emitting diode. The transistor TR to which the first electrode E1 is connected may be a driving transistor or a transistor electrically connected to the driving transistor. The first electrode E1 may be formed of a reflective conductive material or a semi-transmissive conductive material, or may be formed of a transparent conductive material. The first electrode E1 may include a transparent conductive material such as indium tin oxide (ITO) or indium zinc oxide (IZO). The first electrode E1 may include a metal or metal alloy such as lithium (Li), calcium (Ca), aluminum (Al), silver (Ag), magnesium (Mg), or gold (Au).

A pixel definition layer PDL may be positioned on the second planarization layer VIA2 and the first electrode E1. The pixel definition layer PDL may be called a bank or a barrier rib, and may have an opening overlapping the first electrode E1. The pixel definition layer PDL may include an organic insulating material such as a general purpose polymer such as polymethyl methacrylate or polystyrene, a polymer derivative having a phenolic group, an acrylic polymer, an imide polymer, or a siloxane polymer.

A light emitting layer EL of the light emitting diode LED may be positioned on the first electrode E1. In addition to the emission layer EL, a functional layer including at least one of a hole injection layer, a hole transport layer, an electron transport layer, and an electron injection layer may be positioned on the first electrode E1.

A second electrode E2 of the light emitting diode LED may be positioned on the light emitting layer EL. The second electrode E2 may be referred to as a common electrode. The second electrode E2 is formed of a metal or metal alloy having a low work function, such as calcium (Ca), barium (Ba), magnesium (Mg), aluminum (Al), or silver (Ag), to improve light transmittance by forming a thin layer. The second electrode E2 may include a transparent conductive oxide such as indium tin oxide (ITO) or indium zinc oxide (IZO).

The first electrode E1, the light emitting layer EL, and the second electrode E2 of each pixel may form a light emitting diode LED such as an organic light emitting diode. The first electrode E1 may be an anode, and the second electrode E2 may be a cathode. A light emitting area of the light emitting diode LED may correspond to a pixel.

A capping layer CPL may be positioned on the second electrode E2. The capping layer CPL may improve light efficiency by adjusting the refractive index. The capping layer CPL may be positioned to entirely cover the second electrode E2. The capping layer CPL may include an organic insulating material or an inorganic insulating material.

An encapsulation layer EN may be positioned on the capping layer CPL. The encapsulation layer EN may encapsulate the light emitting diode LED to prevent penetration of moisture or oxygen from the outside. The encapsulation layer EN may be a thin film encapsulation layer which includes a first inorganic layer EIL1, the second inorganic layer EIL2, and an organic layer EOL between the first inorganic layer EIL1 and the second inorganic layer EIL2.

A touch sensor layer TS including touch electrodes may be positioned on the encapsulation layer EN. An anti-reflection layer AR may be positioned on the touch sensor layer TS to reduce reflection of external light.

A protective film PF may be positioned under the substrate SB. The display panel DP may be protected during the manufacturing process of the display device using the protective film PF. The protective film PF may include a polymer such as polyethylene terephthalate, a silicone-based polymer (e.g., polydimethylsiloxane), or an elastomer (e.g., elastomeric polyurethane). A protective sheet PST (also referred to as a cover panel) may be positioned under the protective film PF. The protective sheet PST may be attached to the rear surface of the protective film PF, and may protect the display panel DP from the environment (e.g., impact, electromagnetic waves, heat, noise, etc.) on the rear surface of the display panel DP, and the protective sheet PST may have a structure in which a shielding layer, a support layer, a cushion layer, and the like are stacked. The shielding layer may prevent electromagnetic interference (EMI) or the like from flowing into the display panel DP from the rear surface of the display panel DP. The shielding layer may be a metal layer including a metal having excellent thermal conductivity as well as shielding performance, such as copper or aluminum. The support layer may be provided to secure strength of the protective sheet PST and couple/separate the cushion layer to other layers or members. The support layer may be a plastic layer made of a polymer such as polyethylene terephthalate or polyimide. The cushion layer may absorb shock and prevent damage to the display panel DP. For example, the cushion layer can prevent damage to the display panel DP due to external shock and can relieve shock and stress when the electronic device 1 is dropped. The cushion layer may be a porous layer formed of a material such as polyurethane or polyethylene. The cushion layer may include a foam resin. An adhesive layer such as a pressure-sensitive adhesive may be positioned between the shield layer and the support layer, and between the support layer and the cushion layer to attach them. In addition to the aforementioned layers, the protective sheet PST may further include functional layers such as a light blocking layer and a heat dissipation layer.

While the present disclosure has been described with reference to embodiments thereof, it will be apparent to those of ordinary skill in the art that various changes and modifications may be made thereto without departing from the scope and spirit of the present disclosure as set forth in the following claims.

What is claimed is:

1. An adhesive film, comprising:
an adhesive layer;
a first liner disposed on a first surface of the adhesive layer; and
a second liner disposed on a second surface of the adhesive layer,
wherein the first liner comprises:
a body overlapping the adhesive layer, and
a plurality of wings extending from the body without overlapping the adhesive layer.

2. The adhesive film of claim 1, wherein:
the body includes first and second sides parallel to a first direction, and third and fourth sides parallel to a second direction crossing the first direction, and
the plurality of wings include a first wing and a second wing extending in a direction parallel to the second direction from the first side and the second side.

3. The adhesive film of claim 2, wherein:
the plurality of wings further include a third wing and a fourth wing extending in a direction parallel to the first direction from the third side and the fourth side.

4. The adhesive film of claim 1, wherein:
the body and the plurality of wings are integrally formed.

5. The adhesive film of claim 1, wherein:
the first liner has a cross-shaped planar shape, and
the second liner has a rectangular planar shape.

6. The adhesive film of claim 1, further comprising:
a plurality of alignment marks formed in the first liner.

7. The adhesive film of claim 6, wherein:
the plurality of alignment marks are disposed in the body.

8. The adhesive film of claim 6, wherein:
the plurality of alignment marks are disposed in the plurality of wings.

9. The adhesive film of claim 6, wherein:
the plurality of alignment marks are printed on the first liner, engraved on the first liner, or formed to pass through the first liner.

10. A method of manufacturing a display device, comprising:
providing an adhesive sheet comprising an adhesive layer and a liner;
forming a laminate in which the adhesive sheet and a display panel are bonded together;
loading the laminate onto a pad so that the display panel faces the pad;
loading a cover window into a jig;
preforming the display panel by applying an external force to the liner to bring the display panel into close contact with a surface of the pad;
removing the liner; and
bonding the display panel and the cover window.

11. The method of manufacturing the display device of claim 10, wherein:
the pad includes an adhesive layer on a surface of the pad which contacts the display panel.

12. The method of manufacturing the display device of claim 11, wherein:
the surface of the pad has an adhesive force of about 0.4 kgf/mm to about 1.5 kgf/mm.

13. The method of manufacturing the display device of claim 10, wherein:
the pad includes vacuum holes which communicate with the surface of the pad.

14. The method of manufacturing the display device of claim 10, wherein:
the liner includes a body overlapping the adhesive layer, and a plurality of wings extending from the body without overlapping the adhesive layer.

15. The method of manufacturing the display device of claim 14, wherein:
the body includes first and second sides parallel to a first direction, and third and fourth sides parallel to a second direction crossing the first direction,
the plurality of wings include a first wing and a second wing extending in a direction parallel to the second direction from the first side and the second side, and
the first wing and the second wing are clamped in the preforming of the display panel.

16. The method of manufacturing the display device of claim 15, wherein:
the plurality of wings further include third wings and fourth wings extending from the third and fourth sides in a direction parallel to the first direction.

17. The method of manufacturing the display device of claim 10, wherein:
a plurality of alignment marks are formed in the liner, and
the display panel and the cover window are aligned using the plurality of alignment marks.

18. The method of manufacturing the display device of claim 17, wherein:
when the adhesive sheet and the display panel are bonded, an alignment error between the liner and the display panel is obtained using the plurality of alignment marks; and
when the display panel and the cover window are aligned, an alignment position of the display panel and the cover window is corrected using the alignment error.

19. The method of manufacturing a display device of claim 17, wherein:
the liner includes a body overlapping the adhesive layer, and a plurality of wings extending from the body without overlapping the adhesive layer,
the plurality of alignment marks are formed in the body, and
positions of the plurality of alignment marks are not distorted in a state in which the display panel is preformed.

20. The method of manufacturing a display device of claim 17, wherein:
the display panel and the pad are aligned using the plurality of alignment marks when the laminate is loaded.
